(19) United States
(12) Patent Application Publication
(10) Pub. No.: US 2020/0258090 A1
(43) Pub. Date: Aug. 13, 2020

(54) DEVICE SAFETY NOTIFICATION METHOD AND SYSTEM

(71) Applicant: F-Secure Corporation, Helsinki (FI)

(72) Inventor: Antti Järvinen, Helsinki (FI)

(21) Appl. No.: 16/787,903

(22) Filed: Feb. 11, 2020

(30) Foreign Application Priority Data
Feb. 12, 2019 (GB) 1901942.1

(51) Int. Cl. G06Q 30/00; G06F 16/953; H04L 29/12; H04L 12/18

(52) U.S. Cl. CPC G06Q 30/014; G06F 16/953; H04L 61/6022; H04L 12/1895; H04L 61/2015

(57) ABSTRACT

A computer implemented method of identifying potentially unsafe devices or devices otherwise subject to a product recall, and which devices are registered to a network, and of notifying a user or administrator. The method comprises registering computer devices to the network and collecting data associated with those devices, using the collected data to identify the device type of the registered devices, identifying device types having associated device safety notices, comparing the device types of computer devices registered to the network with the device types having associated device safety notices to determine if any of the computer devices are unsafe devices or are otherwise subject to a product recall, and for devices so identified, notifying the user or administrator of the unsafe device or devices.

### TECHNICAL FIELD

The present invention relates to device safety notifications.

### BACKGROUND

Occasionally, safety issues with a device are discovered after that device has been sold. For example, an airbag deployment issue in a particular make of car may be discovered after the car is first sold. This may prompt a device recall by the manufacturer, or by a supplier of the device or by a government body. Safety issues may also relate to a particular component (e.g. a battery) or accessory (e.g. power supply) of a product.

A problem with existing recall procedures is the difficulty of reaching owners of the products, to make them aware of the recall notice. A safety critical recall can easily be missed, in particular if a consumer fails to register the product with the producer/seller after purchase. When using traditional communication methods such as newspaper advertisements, and information on the manufacturer's website, recalls are considered successful if just 30% of the unsafe products are returned to the manufacturer after the recall notice has been issued.

US2018/253733 describes the use of RFID readers placed around a user's home to facilitate receipt of product recall notifications. For example, an RFID reader in the fridge can detect a food product placed in the fridge, and send related information to a control circuit, which determines if there is a recall notification for that product. However, this solution requires RFID tags on the products as well as multiple RFID readers placed around the house. Unsafe products that are located too far away from an RFID reader or which do not have RFID tags may not be detected.

Hence, there is a need for improved methods and systems for facilitating effective product safety notifications. Specifically, there is a need for methods and systems that reduce the need for unnecessary or duplicated technical hardware.

### SUMMARY

According to a first aspect of the present invention there is provided a computer implemented method of identifying potentially unsafe devices or devices otherwise subject to a product recall, and which devices are registered to a network, and of notifying a user or administrator. The method comprises registering computer devices to the network and collecting data associated with those devices, using the collected data to identify the device type of the registered devices, identifying device types having associated device safety notices, comparing the device types of computer devices registered to the network with the device types having associated device safety notices to determine if any of the computer devices are unsafe devices or are otherwise subject to a product recall, and for devices so identified, notifying the user or administrator of the unsafe device or devices. The network may be a wireless network.

The collected data may comprise fingerprint information of the device such as a Media Access Control, MAC, address and/or information received with and/or via DHCP-protocol. The step of using the collected data may comprise mapping fingerprint information of the device, such as the MAC address and/or information received with and/or via DHCP-protocol, to the device type of the registered computer devices. The device type can include at least one of a device manufacturer, production date, batch number, version number, and serial number. The collected data may comprise fingerprint information of the device, such as network fingerprint information of the device, i.e. properties how the device is operating in the network, such properties can be for example at least any of the following: information in DHCP-messages, the properties of TCP/IP-messages, IP-addresses the device is communicating with. In one example embodiment the collected data comprises information received with and/or via DHCP-protocol.

The method may comprise identifying fingerprints for known device types and maintaining a mapping between those fingerprints and the associated device types, wherein said step of using the collected data to identify the device type of registered devices comprises comparing the collected data to the fingerprints.

The step of identifying device types having associated device safety notices may comprise automatically downloading device safety information comprising device types and safety notices associated with those device types from one or more remote databases. The device safety information can be filtered to exclude device types that cannot be registered to the network.

The method may also comprise obtaining location data in respect of the one or more registered computer devices, and obtaining location information indicating locations of device types having associated device safety notices. The step of determining if any of the computer devices are unsafe devices may then further comprise comparing the location data of the one or more computer devices with the location information. The location data may comprise the location of the router to which the computer devices are connected and/or the location of the computer devices themselves.

The step of notifying the user or administrator may comprise displaying a message on a user interface. When the safety notice of an identified device relates to an unsafe component or an unsafe accessory of the device, the method may comprise notifying the user or the administrator of the unsafe component or accessory.

The step of registering can be carried out at a router of the network. The step of identifying device types having associated device safety notices may comprise, at a backend system, maintaining an update table comprising the device types and the associated safety notices and sending the update table to the router. The step of comparing device types may be carried out at the router after receiving the update table from the backend system.

Following notification of the user or administrator of the unsafe device or devices, the method may further comprise receiving via a user interface a notification that a corrective action has been taken.

According to a second aspect of the present invention there is provided a system for identifying unsafe devices or devices otherwise subject to a product recall and registered to a network, and for notifying a user or administrator. The system comprises a router of the network configured to register computer devices to the network, to collect data associated with those devices, and to use the collected data to identify the device type of the registered devices, and a backend system configured to obtain data identifying device types having associated device safety notices and to send that data to the router. The router is further configured to compare the device types of computer devices registered to the network with the device types having associated device safety notices to determine if any of the computer devices are unsafe devices, and for devices so identified, notify the user or administrator of the unsafe device or devices.

The collected data may comprise fingerprint information of the device such as a Media Access Control, MAC, address and/or information received with and/or via DHCP-protocol. The router can be configured to use the collected data by mapping the fingerprint information of the device such as MAC address and/or information received with and/or via DHCP-protocol to the device type of the registered computer devices. The device type can include at least one of a device manufacturer, production date, batch number, version number, and serial number. The collected data may comprise fingerprint information of the device, such as network fingerprint information of the device, i.e. properties how the device is operating in the network, such properties can be for example at least any of the following: information in DHCP-messages, the properties of TCP/IP-messages, IP-addresses the device is communicating with. In one example embodiment the collected data comprises information received with and/or via DHCP-protocol.

The backend system may be further configured to identify fingerprints for known device types, maintain a mapping between those fingerprints and the associated device types, and send the mapping to the router. The backend system may comprise a device information database for storing the fingerprints, the device types and the mapping between them. The backend system can be configured to obtain the fingerprints for known devices from one or more device manufacturers. The backend system may comprise a data crawler configured to automatically download the data identifying device types having associated device safety notices from one or more remote databases. The data crawler can be configured to filter the data identifying device types having associated device safety notices to exclude device types that cannot be registered to the network.

The router can be configured to obtain location data in respect of the one or more registered computer devices, and the backend system can be configured to send location information indicating locations of unsafe devices to the router. The router can then compare the location data of the one or more computer devices with the location information when determining if any computer devices are unsafe devices. The location data may comprise the location of the router and/or the location of the one or more computer devices. The router can comprises a user interface for displaying safety notifications.

### BRIEF DESCRIPTION OF THE DRAWINGS

FIG. 1 is a schematic diagram of a system for detecting unsafe devices according to an embodiment; and

FIG. 2 is a flow diagram of a method of detecting unsafe devices according to an embodiment.

### DETAILED DESCRIPTION

In order to access a WiFi network, wireless computer devices (e.g. smartphones, IoT devices and computers) must first register with a Wi-Fi router. As part of the registration process the computer device and the router exchange information including for example a device Media Access Control, MAC, address. The Wi-Fi router will typically maintain a table listing registered devices and certain relevant information such that, once registered, devices may disconnect and re-connect without having to re-register.

In some cases, routers also perform a separate device identification step in which the information exchanged during registration is used to identify the type of device that is registered. One such router is the SENSE™ router by F-Secure™ Helsinki, Finland. For example, the router may identify a device as being an iPhone 10™ or a Samsung Galaxy S9™. By identifying the type of device, the router can adapt to the device's security needs, as different types of connected devices require different types of protection. The device type may comprise information such as the device manufacturer, version number, batch number, serial number etc.

Typically, a security provider's backend system will crawl the Internet to identify fingerprints for known devices and construct a table mapping fingerprints to device types. Fingerprints may be constructed using persistent information such as a device type's MAC address, information received with and/or via DHCP-protocol, fingerprint information of the device, such as network fingerprint information of the device, i.e. properties how the device is operating in the network, such properties can be for example at least any of the following: information in DHCP-messages, the properties of TCP/IP-messages, IP-addresses the device is communicating with. The table may be pre-filtered to eliminate device types that are not relevant to the security service provided by the service's routers. The filtered tables are then pushed out to the routers via the Internet. A router obtains fingerprints for locally registered devices (from the information held in the router's device registration table) and compares these to the fingerprints in the table received from the backend in order to identify the locally registered devices. The router can then, for example, apply security rules specific to device types. These rules may also be pushed to the routers from the backend, e.g. together with the filtered tables. Updates to the table may be delivered periodically to the router to take account of newly identified device types and new security rules.

The present inventors have recognised that these known, router-deployed device type identification procedures can be employed in a new and surprising way to alert users and network administrators to relevant product recall information, potentially reducing the risks associated with using unsafe devices. In the following, reference is made to “users”, although it will be appreciated that a user may be a device user such as a home owner or family member, or a network administrator in the case of a corporate WLAN network.

Product recall information is published by device safety authorities in public databases, e.g. in the European Union (EU) this is in the RAPEX-database: (https://ec.europa.eu/consumers/consumers_safety/safety_products/rapex/alerts/repository/content/pages/rapex/index_en.htm) and in the US by the Consumer Protection Safety Commission: (https://www.cpsc.gov/).

By combining the device type identification capability of a router, such as the F-Secure SENSE router, with the publicly available recall information, targeted recall notifications can be presented to users. Notification can be provided via the router's user interface (e.g. a LED display), for example when the recalled product does not have a user interface of its own, as is the case with many types of IoT devices. Alternatively or in addition, a router may communicate with the user via an application, such as a smartphone application (app). The app may provide a notification to the user in response to the router identifying an unsafe device type connected to the router's Wi-Fi network. In some cases the router or an app may cause an alert to be sent to the potentially faulty device itself, where that device has a capability to alert a user, e.g. a smartphone or smart TV. The system thereby makes users aware of safety hazards relating to Wi-Fi connected devices with no or minimal input from the users. Depending on the level of information obtained from the connected devices, different levels of accuracy regarding recall notifications or other product safety information can be provided to a user.

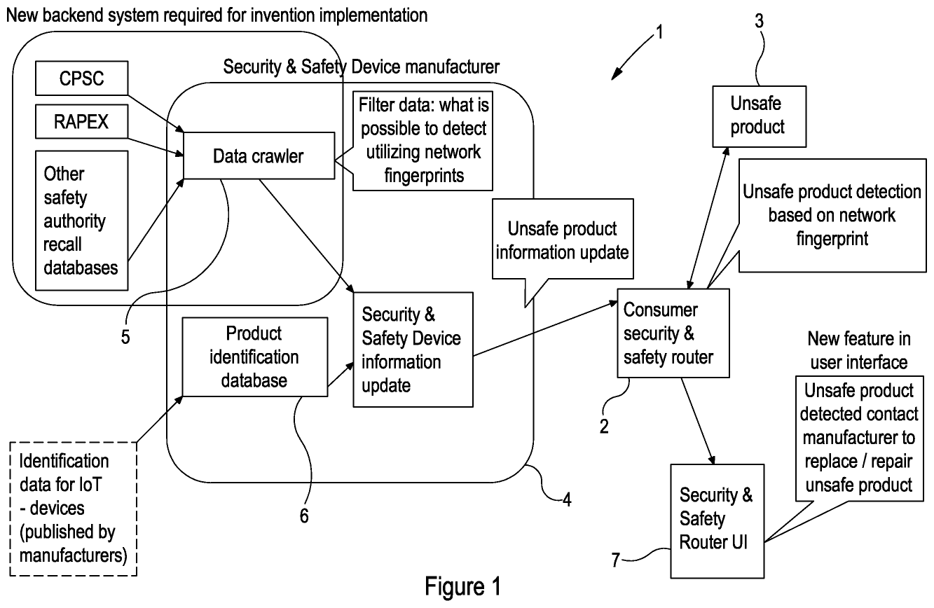

FIG. 1 shows a system 1 for identifying devices subject to a product recall notice (or other safety notification) registered to a Wi-Fi router according to an embodiment. In this example the wireless network is a Wireless Local Area Network (WLAN) commonly referred to as a Wi-Fi network. Components of the system will comprise computer devices having appropriate processors, memories etc, and utilising program code. The system 1 comprises a Wi-Fi router 2 with which a number of devices are registered. Registration will have been performed using some known procedure, e.g. using a graphical user interface presented on some already registered device such as a PC or smartphone, or using the Wi-Fi Protected Setup (WPS) protocol which allows registration by pressing WPS buttons substantially simultaneously on the Wi-Fi router and on the device being registered. During the initial registration process, the router 2 obtains e.g. the device's MAC address and potentially other characteristic information. [NB. It is envisaged that, in the near future, IoT device standards may require IoT devices to be supplied with a unique identification number, which may be obtained and stored by the router.] The router compares the MAC address and/or other characteristic information to the table of device fingerprints in order to identify the type. The device type may comprise the device manufacturer, version, production date, batch number, serial number etc.

The system 1 also comprises a backend system 4 with a data crawler 5 and a device identification database 6. The backend system 4 may be maintained by the same security service provider that manages the router 2. As discussed above, in a known way the data crawler 5 crawls the Internet to identify data that is substantially unique to specific device types that are Wi-Fi enabled. For example, the crawler 5 may identify a Wi-Fi device type's MAC address from an OEM's website. From this data the crawler 5 determines a fingerprint for the device type. This fingerprint may simply be an assembly of the obtained data, or may be, e.g. a hash generated from that data. The fingerprints and device types are added to a database. Prior to being added to the database the backend system may filter entries to remove any that are known to be irrelevant in the sense that they cannot be connected to a Wi-Fi router and/or for some other reason. In some cases, Wi-Fi device manufacturers may push information to the backend for addition to the table (e.g. by agreement with the security service provider).

The backend system 4 also uses the data crawler 5 or a separate application to retrieve data from a CPSC, RAPEX and other remote safety authority recall databases. This information will typically include device types (i.e. names) and some indication of the reason for the recall. The backend system then performs a lookup in the fingerprint table, using the device type, to identify devices that are subject to a product recall. If a recall exists, the table is updated so that each entry comprises at least the device type, fingerprint, and product recall indication. Again, the information from the product recall databases may be filtered before looking up the table and updating the table. Entries may also include rules for generating the fingerprint if this is not consistent. Entries in the table that are subject to a product recall are then extracted into an update table that is pushed out to the routers 2 over the Internet. In some cases, e.g. to reduce the volume of data sent, only delta information may be pushed out, with routers 2 using the delta data to update already stored tables.

As has already been discussed, using known processes the router 2 will have created a device registration table including, for each registered device 3, certain characteristic information. The table may also contain for at least some of these devices 3 a fingerprint. Using the update table pushed to the router 2 by the backend system 4, the router 2 is able to identify any devices 3 present in the registration table that are subject to a product recall or safety notification. This may involve a comparison of the fingerprints in the registration table and in the update table. If the router 2 has not already generated a fingerprint for a device 3, it may do this by applying a fingerprint generation rule included in the update table. In some cases, the registration table may have already performed a device type identification procedure by communicating with the backend system, in which case it is only necessary to search the registration table for device types included in the update table. Of course, in this case the update table may not contain fingerprints at all.

In the event that the device type of a device 3 included in the router's registration table matches a device type in the update table, then the router 2 determines that it is a potentially unsafe or otherwise recalled device 3. The router 2 then displays a device safety notification on its user interface 7. The notification may comprise text such as “Unsafe device detected; device type; contact manufacturer to replace”. Alternatively or in addition the notification may provide a link to the public authority recall notice or manufacturer's page.

The router's approximate physical location may be known based on its IP-address. The router has a public address provided by the Internet Service Provider (ISP). For example, the physical location associated with the IP address can be estimated using Geo-IP. Sometimes unsafe products are only sold in certain markets (e.g. specific production batches or different power supplies in different markets). The recall may then be limited only to countries/areas where the faulty device has been sold. In another scenario, only devices currently located in a specific country may be recalled. For example, a recall of power supplies may only relate to countries having a 230 V mains supply, and not to countries with a 110 V main supply (as the shock from a lower voltage supply is less dangerous). Hence, by comparing the physical location of the router 2 with device type location information (if available from the recall information) it may be possible to reduce false positive product safety notifications to end users.

The described system can provide improvements to device safety and recall procedures for devices with Wi-Fi capabilities. It is appreciated that Wi-Fi connected devices, which are seeing increased growth with the emergence of the “Internet of Things” (IoT), can be handled separately from other devices in order to reach users with targeted safety notifications. For users, it is difficult to monitor safety hazards and related recall procedures of IoT devices, because, without any direct interface to users, manufacturers have to use traditional media coverage methods, such as newspaper advertisements, to notify the users of the issue. When IoT is integrated into Heating, Ventilation and Air-Conditioning (HVAC) systems or other household equipment for example, owners may not even be aware of the presence of a device on their network let alone that it is subject to a product recall. Cheap IoT devices in particular can introduce electrical safety issues and fire hazards, as well as information security problems. There is also evidence that IoT-sensors, which are used to improve safety, do not always operate correctly, and thus provide a false sense of security: (e.g. NEST smoke alarm recall 2014: https://www.cpsc.gov/Recalls/2014/Nest-Labs-Recalls-to-Repair-Nest-Protect-Smoke-CO-Alarms/).

The described system allows consumers to be notified of unsafe devices they may not even be aware of being in their household. By delivering targeted messages to consumers, higher accuracy and higher recall penetration can be achieved without the need to register IoT-devices (some of which may not even have a physical or graphical user interface) with the manufacturer or to monitor public recall data.

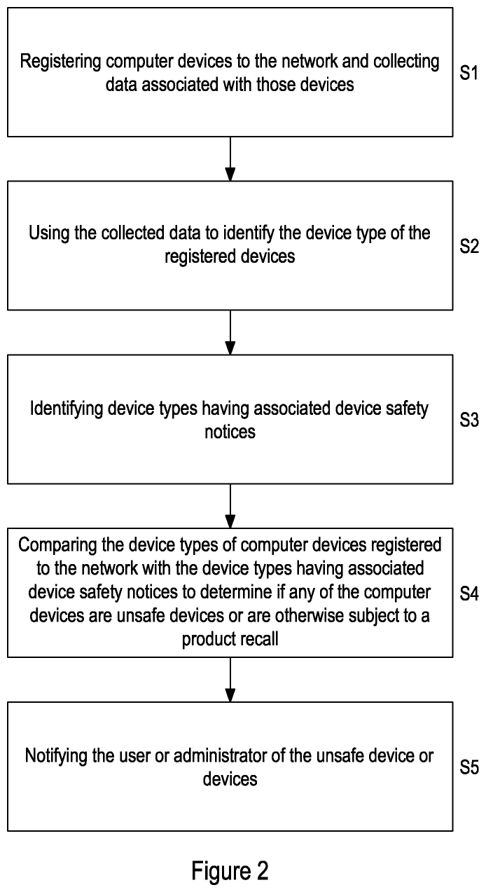

FIG. 2 shows a flow diagram of a method of identifying potentially unsafe devices or devices otherwise subject to a product recall, and of notifying a user or administrator, the method comprising. The method comprises first registering computer devices to the network and collecting data associated with those devices (Step S1), and then using the collected data to identify the device type of the registered devices (Step S2). The method further comprises obtaining data identifying device types having associated device safety notices (Step S3), and comparing the device types of computer devices registered to the network with the device types having associated device safety notices to determine if any of the computer devices are unsafe devices or are otherwise subject to a product recall (Step S4). For devices so identified, the user or administrator is notified of the unsafe device or devices (Step S5). An unsafe device may be a device with an unsafe component (e.g. a battery) or an unsafe accessory (e.g. a power cord), which may be specified in the safety notice associated with the device. In such circumstances the notification sent to the user may prompt the user to check if the unsafe component or accessory is present. This latter notification may be useful, for example, where the fault component or part is a sub-component of a connected device such as a power lead. As in this case the router may not be able to detect that the user has taken action, for example to replace a fault power lead, the router, via its own user interface if it has one or via an appropriate app, may provide a means to allow the user to inform the router that appropriate action has been taken (e.g. thereby allowing the notification to be removed).

In some cases product recall information may be specific to certain categories of a particular product type, for example to a geographic location (or purchase or use) or to a purchase date. The router may also be able to obtain such relevant data from or pertaining to devices registered with the Wi-Fi router.

It will be appreciated that various modifications may be made to the above described embodiments without departing from the scope of the present invention. For example, whilst the embodiments described above are concerned with a Wi-Fi network, the invention may be applied in other wireless network types such as Bluetooth™, Zigbee™, and cellular networks such as 4G and 5G, or in wired networks such as Local Area Networks (LANs). Indeed, embodiments may combine multiple technologies in order to cover an increased range of devices. It will also be appreciated that whilst embodiments have been described in the context of home networks, embodiments may also be implemented in enterprise networks and even town and city networks.

In some cases, it may be sufficient to notify the user of a fault and in other cases it may be necessary to prevent one or more functions of the device (or perhaps require a verification that the safety issue has been dealt with/acknowledged. As such, in addition to notifying a user or administrator of an unsafe device on a network, additional security actions may be launched, e.g. by the router, such as limiting the device's capabilities in different ways. For example, depending on the safety issue in question, the router could prevent a device from communicating with an outside network or even turn off device power or automatically order a service for repairing the device.

1. A computer implemented method of identifying potentially unsafe devices or devices otherwise subject to a product recall, and which devices are registered to a network, and of notifying a user or administrator, the method comprising:
registering computer devices to the network and collecting data associated with those devices;
using the collected data to identify the device type of the registered devices;
identifying device types having associated device safety notices;
comparing the device types of computer devices registered to the network with the device types having associated device safety notices to determine if any of the computer devices are unsafe devices or are otherwise subject to a product recall; and
for devices so identified, notifying the user or administrator of the unsafe device or devices.

2. The method according to claim 1, wherein the collected data comprises fingerprint information of the device, a Media Access Control, MAC, address and/or information received with and/or via DHCP-protocol.

3. The method according to claim 2, wherein the step of using the collected data comprises mapping the fingerprint information of the device, MAC address and/or information received with and/or via DHCP-protocol to the device type of the registered computer devices.

4. The method according to claim 1, wherein the device type includes at least one of a device manufacturer, production date, batch number, version number, and serial number.

5. The method according to claim 1 and comprising identifying fingerprints for known device types and maintaining a mapping between those fingerprints and the associated device types, wherein said step of using the collected data to identify the device type of registered devices comprises comparing the collected data to the fingerprints.

6. The method according to claim 1, wherein the step of identifying device types having associated device safety notices comprises automatically downloading device safety information comprising device types and safety notices associated with those device types from one or more remote databases.

7. The method according to claim 6 and comprising filtering said device safety information to exclude device types that cannot be registered to the network.

8. The method according to claim 1 comprising:
obtaining location data in respect of the one or more registered computer devices;
obtaining location information indicating locations of device types having associated device safety notices, wherein the step of determining if any of the computer devices are unsafe devices further comprises comparing the location data of the one or more computer devices with the location information.

9. The method according to claim 1, wherein the step of notifying the user or administrator comprises displaying a message on a user interface.

10. The method according to claim 1, when the safety notice of an identified device relates to an unsafe component or an unsafe accessory of the device, comprising notifying the user or the administrator of the unsafe component or accessory.

11. The method according to claim 1, wherein the step of registering is carried out at a router of the network.

12. The method according to claim 11, wherein the step of identifying device types having associated device safety notices comprises, at a backend system, maintaining an update table comprising the device types and the associated safety notices and sending the update table to the router.

13. The method according to claim 12, wherein the step of comparing device types is carried out at the router after receiving the update table from the backend system.

14. The method according to claim 11 and comprising, following notification of the user or administrator of the unsafe device or devices, receiving via a user interface a notification that a corrective action has been taken.

15. The method according to claim 1, wherein said network is a wireless network.

16. A system for identifying unsafe devices or devices otherwise subject to a product recall and registered to a network, and for notifying a user or administrator, the system comprising:
a router of the network configured to register computer devices to the network, to collect data associated with those devices, and to use the collected data to identify the device type of the registered devices; and
a backend system configured to obtain data identifying device types having associated device safety notices and to send that data to the router;
wherein the router is further configured to compare the device types of computer devices registered to the network with the device types having associated device safety notices to determine if any of the computer devices are unsafe devices, and for devices so identified, notify the user or administrator of the unsafe device or devices.

17. The system according to claim 16, wherein the collected data comprises fingerprint information of the device such as a Media Access Control, MAC, address and/or information received with and/or via DHCP-protocol.

18. The system according to claim 17, wherein the wherein the router is configured to use the collected data by mapping the fingerprint information of the device such as MAC address and/or information received with and/or via DHCP-protocol to the device type of the registered computer devices.

19. The system according to claim 16, wherein the device type includes at least one of a device manufacturer, production date, batch number, version number, and serial number.

20. The system according to claim 16, wherein the backend system is further configured to:
identify fingerprints for known device types;
maintain a mapping between those fingerprints and the associated device types; and
send the mapping to the router.

21. The system according to claim 20, wherein said backend system comprises a device information database for storing the fingerprints, the device types and the mapping between them.

22. The system according to claim 20, wherein the backend system is configured to obtain the fingerprints for known devices from one or more device manufacturers.

23. The system according to claim 16, wherein the backend system comprises a data crawler configured to automatically download the data identifying device types having associated device safety notices from one or more remote databases.

24. The system according to claim 23, wherein the data crawler is configured to filter the data identifying device types having associated device safety notices to exclude device types that cannot be registered to the network.

25. The system according to claim 16, wherein:
the router is configured to obtain location data in respect of the one or more registered computer devices;
the backend system is configured to send location information indicating locations of unsafe devices to the router; and
the router is further configured to compare the location data of the one or more computer devices with the location information when determining if any computer devices are unsafe devices.

26. The system according to claim 16, wherein the router comprises a user interface for displaying safety notifications.
